(19) United States
(12) Patent Application Publication
(10) Pub. No.: US 2012/0008483 A1
(43) Pub. Date: Jan. 12, 2012

(54) OPTICAL HEAD AND OPTICAL DISC APPARATUS

(75) Inventor: Hideharu MIKAMI, Kawasaki (JP)

(73) Assignee: Hitachi Consumer Electronics Co., Ltd.

(21) Appl. No.: 13/040,434

(22) Filed: Mar. 4, 2011

(30) Foreign Application Priority Data
Jul. 6, 2010 (JP) 2010-154138

(51) Int. Cl. G11B 7/135

(52) U.S. Cl. 369/112.17; 369/112.16; G9B/7.112

(57) ABSTRACT

Reference light for interference with signal light from an optical information recording medium is displaced and reflected by a corner cube prism or the like with high accuracy. The signal light and the displaced reference light are made parallel with each other with high accuracy. The signal light and the reference light are each split using a polarization splitter to generate interference light. Thus, regeneration signals are stabilized. Accordingly, an interference-type optical head and optical disc apparatus of higher quality than conventional ones can be provided.

### CLAIM OF PRIORITY

The present application claims priority from Japanese patent application JP2010-154138 filed on Jul. 6, 2010, the content of which is hereby incorporated by reference into this application.

### BACKGROUND OF THE INVENTION

1. Field of the Invention

The present invention relates to increasing of the S/N of regeneration signals of optical disc apparatus.

2. Description of the Related Art

As for optical discs, the resolution of optical systems therefor has almost reached the limit as Blu-ray discs using a blue semiconductor laser and a high-NA objective lens become commercially available. To further increase the capacity thereof, multi-layering of the recording layer is considered to become a predominant method from now on. In such a multilayer optical disc, the amounts of light beam detected from the recording layers must be approximately equal to one another. For this reason, the reflectance from a particular recording layer must be reduced. However, since optical discs are required to increase their capacity as well as to increase the dubbing speed for video signal or the like, their data transfer speed has also continuously been increased. If the trend continues, it will not be possible to sufficiently increase the S/N ratio of regeneration signals. For this reason, in order to simultaneously pursue multi-layering of the recording layer and such speedups in future, it is essential to increase the S/N of detected signals.

Technologies related to increasing of the S/N of regeneration signals from optical discs are disposed in Japanese Patent Application Laid-Open Publication No. Hei5-342678, Japanese Patent Application Laid-Open Publication No. Hei6-223433, Japanese Patent Application Laid-Open Publication No. Hei6-068470, and the like. Japanese Patent Application Laid-Open Publication No. Hei5-342678 and Japanese Patent Application Laid-Open Publication No. Hei6-223433, which relate to increasing of the S/N of regeneration signals from magneto-optical discs, split light beam emitted by a semiconductor laser before applying the light beam to an optical disc and multiplex the split light beam which is not applied to the optical disc with light beam reflected from the optical disc so that the light beam which is not applied to the optical disc interferes with the reflected light beam. These technologies are intended to amplify the amplitude of a weak signal by increasing the amount of the light beam which is not applied to the optical disc. Essentially, differential detection of transmitted light and reflected light from a polarization beam splitter, which has been employed to detect a signal from a magneto-optical disc, is a detection method which causes the original incident polarization components and the polarization components perpendicular to the incident polarization direction generated by the polarization rotation of a magneto-optical disc to interfere with each other so that the incident polarization components amplify the perpendicular polarization components. Accordingly, an increase in the original incident polarization components allows amplification of the signal. However, the intensity of the light beam incident on the optical disc must be controlled to a certain level or below so as not to delete or overwrite data. On the other hand, the above-mentioned related art spirits light beam for interference with signal light in advance and then causes the light beam to interfere with the signal light without condensing the light beam on the disc. Thus, the intensity of the interference light can be increased to amplify the signal, regardless of the light intensity required on the disc surface. For this reason, in principle, the S/N ratio relative to the noise of the amplifier for converting the photocurrent from the optical detector into a voltage can become higher as the light intensity is increased within the permissible range. Japanese Patent Application Laid-Open Publication No. Hei6-068470 relates to increasing of the S/N of a signal regenerated from an optical disc using a photochromic medium and is intended to amplify a signal by causing light which is not applied to an optical disc to interfere with light reflected from the optical disc, as in Japanese Patent Application Laid-Open Publication No. Hei5-342678 and No. Hei6-223433. As for optical discs using a photochromic medium, the deterioration of the medium is accelerated as the intensity of incident light is increased to reproduce a signal. For this reason, as in the above-mentioned magneto-optic disc, there is a limit to the intensity of the light to be applied to the recording medium.

Japanese Patent Application Laid-Open Publication No. Hei5-342678 causes two beams to interfere with each other and detects the intensity of the interference light. This technology makes variable the optical path length of light for interference reflected from a disc and is intended to secure the amplitude of the interference signal. Japanese Patent Application Laid-Open Publication No. Hei6-223433, Japanese Patent Application Laid-Open Publication No. Hei6-068470, and Japanese Patent Application Laid-Open Publication No. 2008-65961 detect the intensity of interference light, as well as perform differential detection. Thus, these technologies are intended to achieve a high S/N by cancelling the intensity components of beams that do not contribute to a signal and doubling the signal amplitude.

Generally, the amplitude of interference light obtained from interference between two beams depends on the phase difference (optical path difference) between the two beams for interference. For this reason, if the above-mentioned optical path difference varies on the order of the wavelength of the light source used, the amplitude varies and becomes unstable. On the other hand, Japanese Patent Application Laid-Open Publication No. 2008-65961, Japanese Patent Application Laid-Open Publication No. 2008-243273, Japanese Patent Application Laid-Open Publication No. 2008-310942, and Japanese Patent Application Laid-Open Publication No. 2008-269680 generate multiple interference beams having different interference states and generate a signal by performing an operation between these interference beams. Thus, these technologies output an amplified signal not dependent on the interference phase.

### BRIEF SUMMARY OF THE INVENTION

To obtain a properly amplified signal in the above-mentioned signal detection method using optical interference, the positions or optical axis directions of the two beams for interference must be matched. In particular, the matching accuracy between the optical axis directions is required to be as high as the order of 0.001°. For example, Japanese Patent Application Laid-Open Publication No. 2008-65961 is configured so that a beam (reference light) for interference with light reflected from an optical disc (signal light) is reflected by a mirror. However, a slight tilt of the mirror shifts the optical axis, causing an optical axis shift between the signal light and the reference light. On the other hand, Japanese Patent Application Laid-Open Publication No. 2008-243273 can maintain the matching accuracy between the optical axis directions at a high level by condensing reference light using a lens and then reflecting the condensed light using a mirror. This is because even when the mirror that reflects the beam condensed by the lens is tilted, the reflected light again passes through the lens and is converted into parallel light without tilting the optical axis. Similarly, the signal light is condensed on the optical disc by an objective lens and then reflected. Thus, the optical axis thereof does not tilt even when the optical disc-tilts. As such, Japanese Patent Application Laid-Open Publication No. 2008-310942 allows reference light to come into the center of a corner cube prism and then be reflected, increasing the accuracy of the optical axis direction of the reference light. That is, since the optical axis directions of the signal light and the reference light are determined with high accuracy, no shift occurs in optical axis direction even when multiplexing the signal light and the reference light. Thus, the output signal can be kept stable. Japanese Patent Application Laid-Open Publication No. 2008-269680 allows reference light to go out of a beam displacer, corner cube prism, and or like exactly in an anti-parallel direction (that is, the optical axis direction is different by 180°). This increases the accuracy of the optical axis direction of the reference light, preventing a mismatch in optical axis direction between the signal light and the reference light.

However, the above-mentioned Japanese Patent Application Laid-Open Publication No. 2008-243273, Japanese Patent Application Laid-Open Publication No. 2008-310942, and Japanese Patent Application Laid-Open publication No. 2008-269680 multiplex the signal light and the reference light in a state where polarized beams are perpendicular to each other and then generate multiple multiplexed beams having different phase relationships. For this reason, these technologies use a non-polarization beam splitter or non-polarization diffraction grating. These elements make different phase differences in two different polarization states (horizontal polarization and vertical polarization). Generally, it is not easy to control the values of such phase differences to a desired value. This characteristic disadvantageously generates an error in the phase difference between the signal light and the reference light in the generated interference light and thus destabilizes the regeneration signal. Further, generally, it is difficult to correctly control the split ratio of the non-polarization beam splitter (the intensity ratio between the transmitted light and the reflected light). While the above-mentioned conventional technology must achieve a split ratio of 1:1 regardless of the polarization state, it actually generates an error and thus unfavorably destabilizes the regeneration signal.

An advantage of the present invention is to provide an interference-type optical head and optical disc apparatus that easily adjust the axes of two beams, have a high signal amplification effect, and produce stable outputs.

(1) An optical head according to a first aspect of the present invention includes: a light source such as a semiconductor laser; a polarization splitter such as a polarization beam splitter that splits a beam emitted by the light source into a signal beam and a reference beam; a condenser such as a convective lens that condenses the signal beam on an optical information recording medium and emits the condensed beam; a parallel beam emitter such as a corner cube prism that displaces the reference beam and emits the displaced beam so that the displaced reference beam is in parallel with the signal beam reflected in an opposite direction from the optical information recording medium; a second polarization splitter such as a beam displacer that splits polarization of the signal beam and polarization of the reference beam; a multiplexer that multiplexes the signal beam and the reference beam generated by the polarization splitter to generate a multiplexed beam; an interference beam generator such as a Wollaston prism that generates interference beams of the signal beam and the reference beam from the multiplexed beam; and a detector that detects the interference beams generated by the interference beam generator.

Thus, it is possible to multiplex the signal beam and the reference beam with the respective optical axis directions determined with high accuracy and thus to obtain amplifies signals stably.

(2) In (1), the parallel beam emitter preferably includes: a parallel beam reflector such as a corner cube prism that displaces the reference beam generated by the polarization splitter and emits the displaced reference beam in parallel; and the polarization splitter, the polarization splitter reflects the reference beam emitted by the parallel beam reflector.

Thus, even when the signal beam and the reference beam generated by the polarization splitter are emitted in different directions, these beams can be easily made parallel with each other as separated from each other. This reduces the adjustment frequency, reducing the cost of the optical head.

(3) In (2), the parallel beam emitter is preferably a corner cube prism.

Thus, it is possible to easily generate a beam that is to be displaced and reflected in parallel. This facilitates the assembly or adjustment of an optical head.

(4) In (2), the parallel beam reflector preferably includes: a condenser that receives the reference beam at a position thereof different from the center axis thereof in such a manner that the reference beam is in parallel with the center axis; and a mirror disposed at the focus position of the condenser.

Thus, it is possible to generate a beam to be displaced and reflected in parallel using only a low-cost optical component and thus to reduce the cost of an optical head.

(5) In (1), the parallel beam emitter preferably includes: a reflector that emits the reference beam generated by the polarization splitter in a 180° opposite direction without displacing the reference beam; the polarization splitter that multiplexes the signal beam reflected from the optical information recording medium and the reference beam reflected from the reflector to generate a multiplexed beam; and a parallel beam separator such as a beam displacer that separates the signal beam and the reference beam of the multiplexed beam in such a manner that the signal beam and the reference beam are in parallel with each other.

Thus, it is possible to apply an optical component such as a condenser lens to a multiplexed beam obtained by temporarily multiplexing the signal beam and the reference beam and thus to reduce the component number and the adjustment frequency. This reduces the cost of an optical disc.

(6) In (5), the parallel beam separator is preferably a beam displacer.

Thus, the separated signal beam and reference beam can be made parallel with each other with high accuracy. This stabilizes output signals.

(7) In (1), the second polarization splitter and the multiplexer are preferably each a beam displacer.

Thus, multiplexing can be performed simply and with high accuracy. This stabilizes output signals.

(8) In (1), the second polarization splitter and the multiplexer are preferably composed of a single polarization beam splitter.

Thus, the component number and the adjustment frequency can be reduced. This reduces the cost of an optical head.

(9) An optical head includes: a light source such as a semiconductor laser; a polarization splitter such as a polarization beam splitter that splits a beam emitted by the light source into a signal beam and a reference beam; a condenser such as a convective lens that condenses the signal beam on an optical information recording medium and emits the condensed beams; a parallel beam reflector such as a corner cube prism that displaces the reference beam and reflects the displaced reference in parallel; a polarization multiplexer such as a polarization beam splitter that multiplexes the signal beam emitted by the optical information recording medium and the reference beam reflected from the parallel beam reflector to generate a multiplexed beam; an interference beam generator that generates interference beams of the signal beam and the reference beam from the multiplexed beam; and a detector that detects the interference beams generated by the interference beam generator.

Thus, as in (1), it is possible to multiplex the signal beam and the reference beam with the respective optical axis directions determined with high accuracy to generate an interference beam. This stabilizes reproduction signals.

(10)-(18) An optical disc apparatus according to a second aspect of the present invention includes: the optical head according to (1)-(9); a control unit that controls the respective positions of the optical head and the convective lens and the light-emitting state of the semiconductor laser; and a signal processing unit that performs an operation using some or all of outputs of the multiple detectors as inputs and obtains an output of the operation as a regeneration signal.

Thus, the optical disc apparatus can obtain the same advantageous effects as those of (1)-(9).

According to the present invention, it is possible to provide an optical head and optical disc apparatus that can obtain a high signal amplification effect more stably than conventional ones.

### BRIEF DESCRIPTION OF THE DRAWINGS

FIG. 1 is a basic configuration diagram of an optical head according to an embodiment of the present invention;

FIG. 2 is a diagram showing details of a detector for obtaining servo signals;

FIG. 3 is a schematic diagram of a corner cube prism;

FIG. 4 is a schematic diagram of a beam displacer;

FIG. 5A is a diagram showing a configuration where light beam is condensed by a lens and reflected by a mirror when an optical disc is not tilted;

FIG. 5B is a diagram showing a configuration where light beam is condensed by a lens and reflected by a mirror when an optical disc is tilted;

FIG. 6A is a diagram showing that signal light and reference light are made parallel with each other when the polarization beam splitter is not tilted;

FIG. 6B is a diagram showing that signal light and reference light are made parallel with each other even when the polarization beam splitter is tilted;

FIG. 7A is a configuration diagram of a right-angle prism that displaces a beam and reflects the displaced beam in parallel;

FIG. 7B is a configuration diagram of a lens and a mirror that reflect displace a beam and reflect the displaced beam in parallel;

FIG. 8 is a configuration diagram of another optical head according to the present invention that generates interference light from signal light and displaced reference light that are in parallel with each other;

FIG. 9 includes a configuration diagram of the case where a wave plate is omitted for the rotation of a beam displacer and a Wollaston prism and a diagram showing the loci of beams and polarization;

FIG. 10 is a configuration diagram of another embodiment that temporarily multiplexes signal light and reference light and splits the multiplexed light again;

FIG. 11 is a diagram showing another device that correctly reflects reference light in an opposite direction;

FIG. 12 is a diagram of yet another embodiment that simultaneously performs polarization split and multiplexing of signal light and reference light;

FIG. 13 is a diagram showing that polarization split and multiplexing of signal light and reference light are simultaneously performed by a polarization beam splitter;

FIG. 14 is a diagram showing the direction in which a beam comes into a typical polarization beam splitter and the direction in which the beam goes out thereof;

FIG. 15 is a configuration diagram of still another embodiment that multiplexes signal light and reference light with high accuracy without making them parallel with each other so that the signal light and reference light interfere with each other;

FIG. 16 is a configuration diagram of an optical disc apparatus according to the present invention; and

FIG. 17 is a block diagram showing details of a signal processing circuit included in the optical disc apparatus according to the present invention.

### DETAILED DESCRIPTION OF THE INVENTION

### First Embodiment

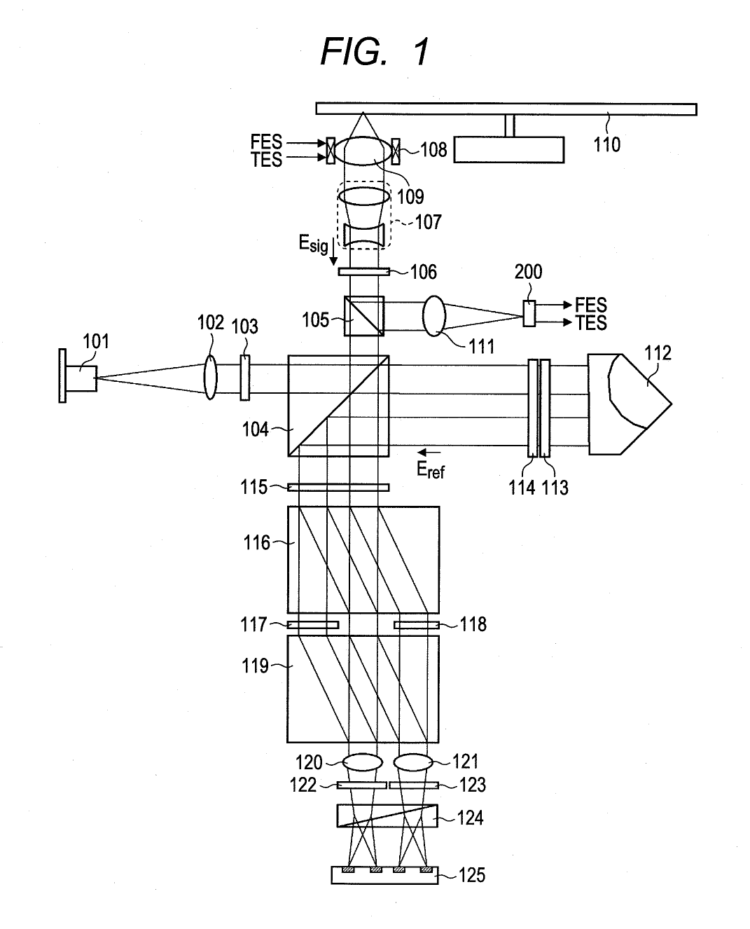

Now, a first embodiment of the present invention will be described with reference to FIG. 1.

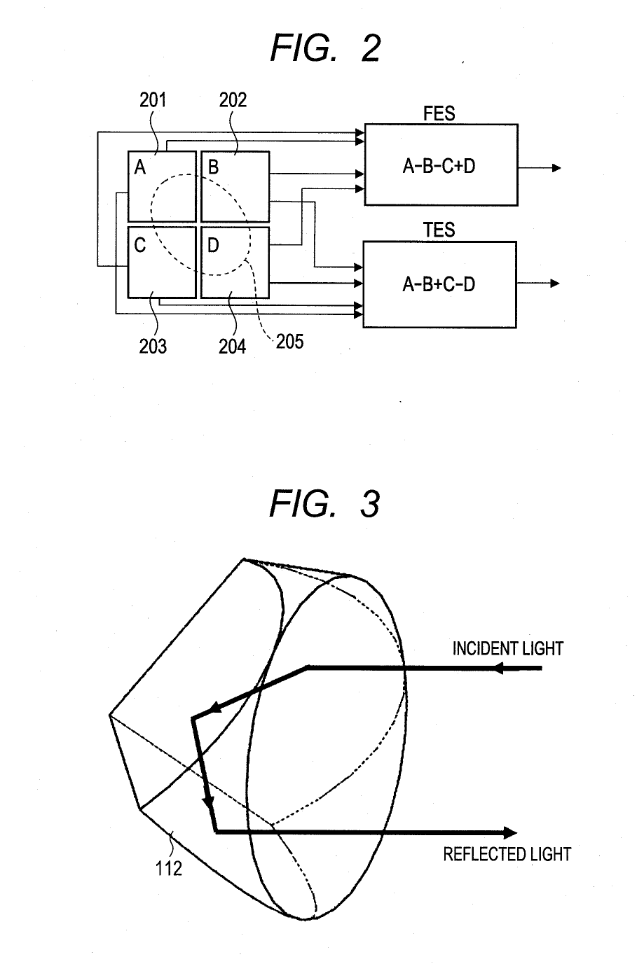

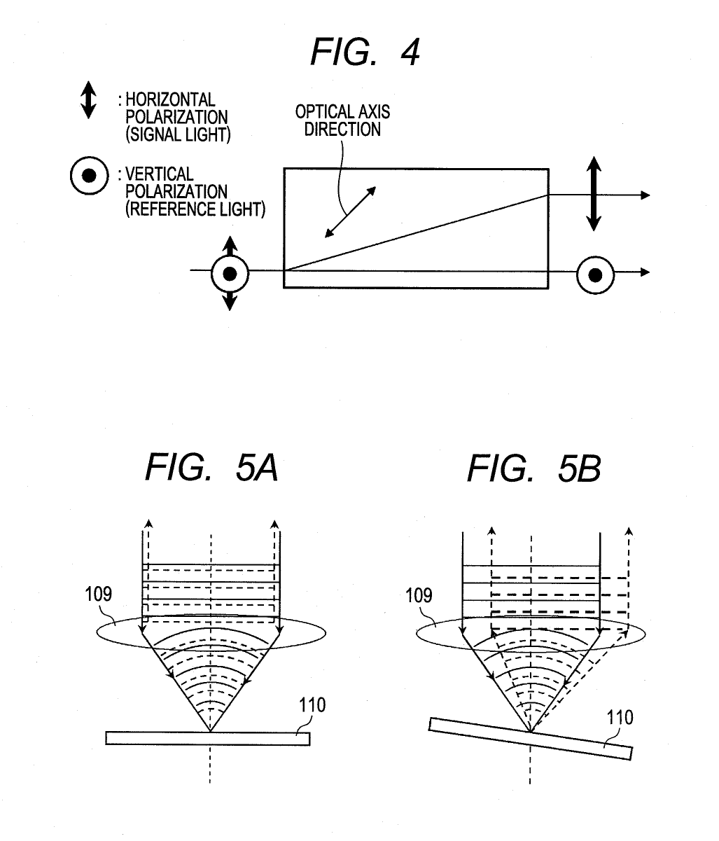

FIG. 1 shows a basic configuration of an optical head according to this embodiment. Light from a semiconductor laser 101 is converted by a collimate lens 102 into parallel beams, which then pass through a half-wave plate 103 and come into a polarization beam splitter 104. The polarization beam splitter 104 has functions of transmitting approximately 100% of p-polarization (hereafter referred to as “horizontal polarization”) incident on its split surface and reflecting approximately 100% of s-polarization (hereafter referred to as “vertical polarization”) incident thereon. The intensity ratio between transmitted light and reflected light can be adjusted by adjusting the rotation angle of the half-wave plate around the optical axis. The reflected light (hereafter referred to as “signal light”) initially comes into a specialized polarization beam splitter 105. As its characteristics, the specialized polarization beam splitter 105 transmits 100% of vertical polarization and reflects part of horizontal polarization and transmits part thereof. Thus, 100% of the incident light passes through the specialized polarization beam splitter 105, passes through a half wave plate 106 so that the light is converted into circular polarization, passes through a beam expander 107 for correcting spherical aberration, and is then condensed on the recording layer of an optical disc 110 by an objective lens 109 mounted on a two-dimensional actuator 108. The light reflected from the optical disc goes back along the same optical path and is converted into parallel light by the objective lens 109, becoming linear polarization whose direction is rotated by 90° relative to that when first coming into the half wave plate 106. The light then comes into the specialized polarization beam splitter 105 and partially passes therethrough and is partially reflected therefrom due to the above-mentioned characteristics. The reflected light comes into a detector 200 via a cylindrical lens 111. As shown in FIG. 2, the detector 200 is divided into four parts 201, 202, 203, and 204 whose output signals are represented by A, B, C, and D, respectively. The detector 200 feeds back a focus error signal (FES) obtained from an operation A−B−C+D and a track error signal (TES) obtained from an operation A−B+C−D to the voice coil motor of the two-dimensional actuator 108 as currents. On the other hand, the light that has passed through the specialized polarization beam splitter 105 comes into the polarization beam splitter 104. Since the polarization is rotated by 90° and becomes horizontal polarization, it passes through the polarization beam splitter 104. On the other hand, the light (hereafter referred to as “reference light”) emitted by the semiconductor laser 101 and passed from the polarization beam splitter 104 comes into a corner cube prism 112. The corner cube prism is a type of prism as shown in FIG. 3 and, as its characteristics, reflects incident light therewithin three times and emits, as reflected light, a beam traveling in a direction 180° opposite to the incident light (note that the light is displaced). Accordingly, the reflected light travels in a direction opposite to the incident light as displaced in a lateral direction relative to the incident light (in a direction perpendicular to the optical axis) and comes into the polarization beam splitter 104. Since the reflection within the corner cube prism 112 satisfies all reflection conditions, the reflected light is emitted in a polarization state different from that of the incident light. For this reason, a half-wave plate 113 and a quarter-wave plate 114 inserted into the forward and backward optical paths compensate for variations in polarization within the corner cube prism. These wave plates also rotate the light along the backward path by 90° relative to the light along the forward path. If the wavelength of the light is 405 nm and the medium of the corner cube prism is BK7, it is preferred to set the optical axis direction of the half-wave plate 113 to 58.6° relative to the horizontal polarization and set the optical axis of the quarter-wave plate 114 to −17.7° relative to the horizontal polarization (assume that counterclockwise rotation seen from the first incident light is positive). Thus, the light reflected from the corner cube prism 112 is reflected by the polarization beam splitter 104. At that time, the signal light and the reference light have different optical axis positions due to the shift in optical axis position caused by the reflection by the corner cube prism 112; however, the signal light and the reference light are in parallel with each other with high accuracy, as described in detail later. The signal light and the reference light then pass through a half-wave plate (optical axis direction: 22.5° relative to the horizontal polarization) 115 and become +45° linear polarization and −45° linear polarization, respectively, each having horizontal polarization components and vertical polarization components equally. These beams then come into a beam displacer 116 so that the beams are split into horizontal polarization and vertical polarization. The split beams go out thereof in parallel with each other. The beam displacer is a uniaxial crystal block as shown in FIG. 4 and, as its characteristics, transmits polarization (vertical polarization in FIG. 4) perpendicular to the optical axis direction, as well as displaces polarization (horizontal polarization in FIG. 4) perpendicular to the former polarization in the prism and emits the polarization in such a manner that the polarization is displaced from and in parallel with the light being transmitted. Thus, the signal beam and the reference beam are each split into horizontal polarization components and vertical polarization-components which are equal in size. Of these beams, only the horizontal polarization components of the signal light and the vertical polarization components of the reference light are converted into vertical polarization and horizontal polarization, respectively, by half-wave plates (optical axis direction: 45° relative to the horizontal polarization) 117 and 118. The above-mentioned four beams then come into a beam displacer 119, which is the same as the beam displacer 116, becoming two beams where the signal light and the reference light are multiplexed in a mutually perpendicular polarization state. The beams pass through condenser lenses 120 and 121, respectively, pass through half-wave plate 122 (axis direction: 22.5° relative to the horizontal polarization) and a quarter-wave plate (axis direction: 45° relative to the horizontal polarization) 123, respectively, are both split into horizontal polarization components and vertical polarization components (these split beams are interference beams generated by the interference between the signal light and the reference light) by a Wollaston prism 124, and are detected and converted into electrical signals by different light receptors of the detector 125. With regard to an output corresponding to the two interference beams generated from the same multiplexed beam of these electrical signals, an electrical signal corresponding to the difference between the two interference beams is outputted by a differential circuit (not shown). Thus, outputs of electrical signals corresponding to the two multiplexed beams formed by multiplexing the signal light and the reference light having different phase relationships are obtained. These electrical signals (hereafter referred to as “RF1 and RF2”) are inputted into the operation circuit, which then adds to the RFI and RF2 the respective square values, obtains the square roots of the resulting values, and outputs the obtained values as final reproduction signals. (Note that the above-mentioned differential circuit and operation circuit do not necessarily need to be mounted on the optical head and that if these circuits are not mounted on the optical head, the same functions are preferably realized in an optical disc apparatus for controlling the optical head.)

Next, a process of obtaining an amplified signal using optical interference will be described in detail. In both of the multiplexed beams incident on the condenser lenses 120 and 121, the reference light constitutes the horizontal polarization components and the signal light constitutes the vertical polarization components. The polarization is represented by a Jones vector as described below.

$$\frac{1}{\sqrt{2}} ( \begin{matrix}{E}_{r} \\ {E}_{s}\end{matrix} ) \qquad Formula 1$$

where Es represents the electric field of the signal light and Er represents the electric field of the reference light.

The first component of this vector represents the horizontal polarization components, and the second component thereof represents the vertical polarization components. The factor 1/√2 shows that the light beam is split into two beams by the beam splitter. When one of the multiplexed beams passes through the half-wave plate 122, the Jones vector becomes Formula 2 below.

$$( \begin{matrix}cos 45 ° & - sin 45 ° \\ sin 45 ° & cos 45 °\end{matrix} ) ( \begin{matrix}{E}_{r} / \sqrt{2} \\ {E}_{s} / \sqrt{2}\end{matrix} ) = ( \begin{matrix}( {E}_{r} - {E}_{s} ) / 2 \\ ( {E}_{r} + {E}_{s} ) / 2\end{matrix} ) \qquad Formula 2$$

Since this beam passes through a Wollaston prism for splitting the horizontal polarization components and the vertical polarization components, the electric fields of the split beams are represents by Formulas 3 and 4 below.

$$\begin{matrix}\frac{1}{2} ( {E}_{r} - {E}_{s} ) & Formula 3 \\ \frac{1}{2} ( {E}_{r} + {E}_{s} ) & Formula 4\end{matrix}$$

When the other multiplexed beam passes through the half-wave plate 123, the Jones vector becomes Formula 5 below.

$$\frac{1}{\sqrt{2}} ( \begin{matrix}i - cos 90 ° & sin 90 ° \\ sin 90 ° & i + cos 90 °\end{matrix} ) ( \begin{matrix}{E}_{r} / \sqrt{2} \\ - {E}_{s} / \sqrt{2}\end{matrix} ) = ( \begin{matrix}i ( {E}_{r} + i {E}_{s} ) / 2 \\ ( {E}_{r} - i {E}_{s} ) / 2\end{matrix} ) \qquad Formula 5$$

Since this beams pass through a Wollaston prism for splitting the horizontal polarization components and the vertical polarization components, the electric fields of the split beams are represents by Formulas 6 and 7 below.

$$\begin{matrix}\frac{i}{2} ( {E}_{r} + i {E}_{s} ) & Formula 6 \\ \frac{1}{2} ( {E}_{r} - i {E}_{s} ) & Formula 7\end{matrix}$$

Accordingly, the four electrical signals obtained by the detector 125 are represented by Formulas 8, 9, 10, and 11 below. Formula 8 where n represents the conversion efficiency of the detector.

$$\begin{matrix} η {\vert \frac{1}{2} ( {E}_{r} - {E}_{s} ) \vert}^{2} = η ( \frac{1}{4} {\vert {E}_{r} \vert}^{2} + \frac{1}{4} {\vert {E}_{s} \vert}^{2} + \frac{1}{2} \vert {E}_{r} {E}_{s} \vert cos Δφ ) & Formula 8 \\ η {\vert \frac{1}{2} ( {E}_{r} + {E}_{s} ) \vert}^{2} = η ( \frac{1}{4} {\vert {E}_{r} \vert}^{2} + \frac{1}{4} {\vert {E}_{s} \vert}^{2} + \frac{1}{2} \vert {E}_{r} {E}_{s} \vert cos ( Δφ + π ) ) & Formula 9 \\ η {\vert \frac{1}{2} ( {E}_{r} + i {E}_{s} ) \vert}^{2} = η ( \frac{1}{4} {\vert {E}_{r} \vert}^{2} + \frac{1}{4} {\vert {E}_{s} \vert}^{2} + \frac{1}{2} \vert {E}_{r} {E}_{s} \vert cos ( Δφ + π / 2 ) ) & Formula 10 \\ η {\vert \frac{1}{2} ( {E}_{r} - i {E}_{s} ) \vert}^{2} = η ( \frac{1}{4} {\vert {E}_{r} \vert}^{2} + \frac{1}{4} {\vert {E}_{s} \vert}^{2} + \frac{1}{2} \vert {E}_{r} {E}_{s} \vert cos ( Δφ + 3 π / 2 ) ) & Formula 11\end{matrix}$$

The inside of the Cos represents the phase difference between the signal light and the reference light in each interference light. If the electrical signals obtained by the above-mentioned Formulas 8 to 11 are represented by A1, A2, A3, and A4, respectively, differential signals D1 and D2 are obtained as follows.

D₁=A₂−A₁=η|EₛEᵣ|cos Δφ Formula 12

D₂=A₃−A₄=η|EₛEᵣ|sin Δφ Formula 13

The operation circuit then calculates the sum of squares of the D1 and D2 (one of secondary expressions) as shown in Formula 14 below to obtain an output not dependent on the interference phase.

D₁=η|EₛEᵣ| Formula 14

This output takes a shape where the electric field of the signal light is amplified by the electric field of the reference light. Accordingly, even if Es is small for a reason such as the low reflectance of the optical disc so that the signal cannot be correctly regenerated when the signal light is directly detected, it is possible to amplify and correctly reproduce the signal. Note that the square root of this output may be handled as a reproduction signal. This improves the linearly of the signal, simplifying the demodulation of data.

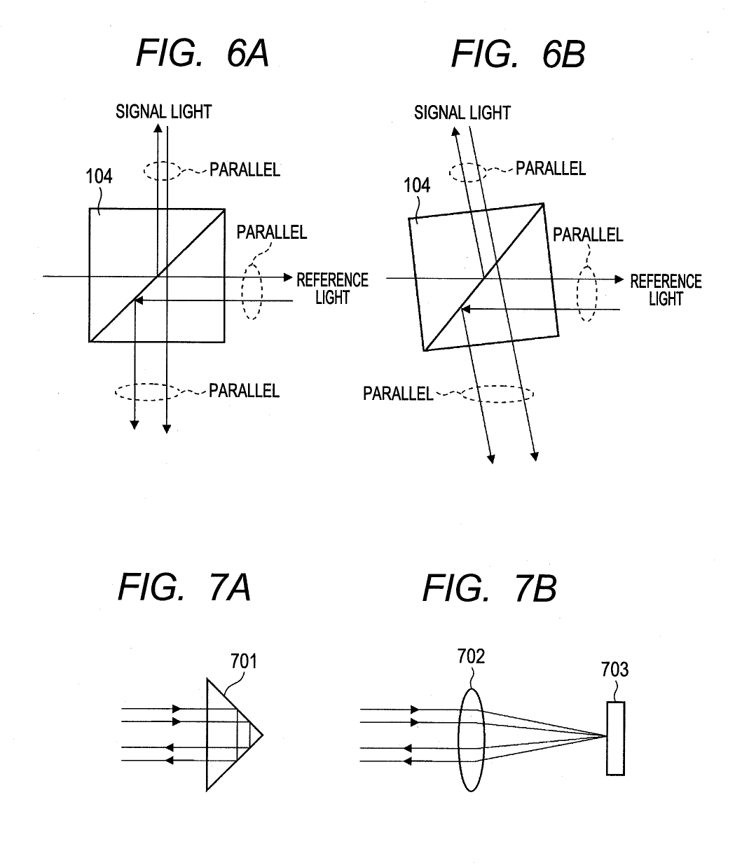

Hereafter, it will be shown that the optical axis directions of the signal light and the reference light can be matched with high accuracy in this embodiment. First, note the optical axis of the signal light. The signal light is condensed on the optical disc 110 by the objective lens 109 and then reflected, and travels back along exactly the same optical path. In principle, a shift in the optical axis direction of a beam is caused by a tilt of an object which reflects the beam. In the above-mentioned configuration, however, a tilt of the optical disc 110 basically causes no variation in the optical axis direction (FIG. 5 shows a case where there is no tilt; FIG. 5B shows a case where a tilt occurs). Although the beam is slightly displaced instead, that is not a problem since allowance is made for a displacement with respect to the quality of interference. Accordingly, the optical axis direction of the signal light is determined with extremely high accuracy. On the other hand, the reference light is reflected by the corner cube prism 112 and then reflected by the polarization beam splitter 104. At that time, the reference light becomes parallel with the signal light. The corner cube prism is characterized in that the incident light and the reflected light are in parallel with each other, regardless of the incident direction. Accordingly, the light axis directions of the incident light and the reflected light agree with each other with high accuracy. On the other hand, since both the signal light and the reference light are once reflected by the polarization beam splitter 104, the signal light and the reference light tilt in the same direction as shown in FIG. 6 when the polarization beam splitter 104 slightly tilts. Thus, the signal light and the reference light are kept parallel with each other (FIG. 6A shows a case where there is no tilt; FIG. 6B shows a case where a tilt occurs). That is, when the signal light and the reference light pass through the polarization beam splitter 104, the respective optical axis directions agree with each other with high accuracy. While the signal light and the reference light are then split and multiplexed by the beam displacers 116 and 119, the above-mentioned properties of the beam displacers prevent the respective optical axis directions from varying, whether each light is displaced or not. Accordingly, when the signal light and the reference light are multiplexed in the beam displacer 119, the respective optical axis directions agree with each other with high accuracy. This allows interference signals of sufficient quality to be generated stably, stabilizing reproduction signals.

In this method, the signal light and the reference light are each split by the beam displacer 116 before multiplexed in different phase relationships. Since the split ratio here can easily be adjusted using the set angle of the half-wave plate 115, a split ratio of 1:1 can be achieved with high accuracy. Further, since the beam displacer 116 separates the horizontal polarization and the vertical polarization, no phase difference basically occurs between the horizontal polarization and the vertical polarization within the split beam, unlike in a non-polarization beam splitter. Accordingly, there occurs no error between the phase difference between the signal light and the reference light in one of the two types of multiplexing and that in the other type of multiplexing. Thus, reproduction signals can be more easily stabilized. The reason why the signal light and the reference can each be split before multiplexed in different phase relationships by the polarization beam splitters as seen above is that the signal light and the reference light are kept un-multiplexed. That is, it is an important point that the signal light and the reference light be in parallel with each other as unsplit after passing through the polarization beam splitter 104. While, in this embodiment, the optical axis direction is determined with high accuracy by reflecting the reference light using the corner cube prism, such high-accuracy determination of the optical axis direction can be accomplished by way of a different device. For example, as shown in FIG. 7A, a right-angle prism may be used. The right-angle prism is a prism having two perpendicular reflection surfaces, and displaces the incident light and emits the reflected light in a 180° opposite direction, as with the corner cube prism. Thus, the right-angle prism can obtain advantages similar to those of the corner cube prism. Alternatively, as shown in FIG. 7B, the reference light may be condensed by a lens 702 and reflected by a mirror 703. In this case, the reference light comes into a position deviating from the central axis of the lens. Thus, the reference light goes out of the lens as displaced. As with the signal light, the optical axis direction of the reflected beam does not vary even when the mirror 702 tilts. Thus, the optical axis direction can be determined with high accuracy.

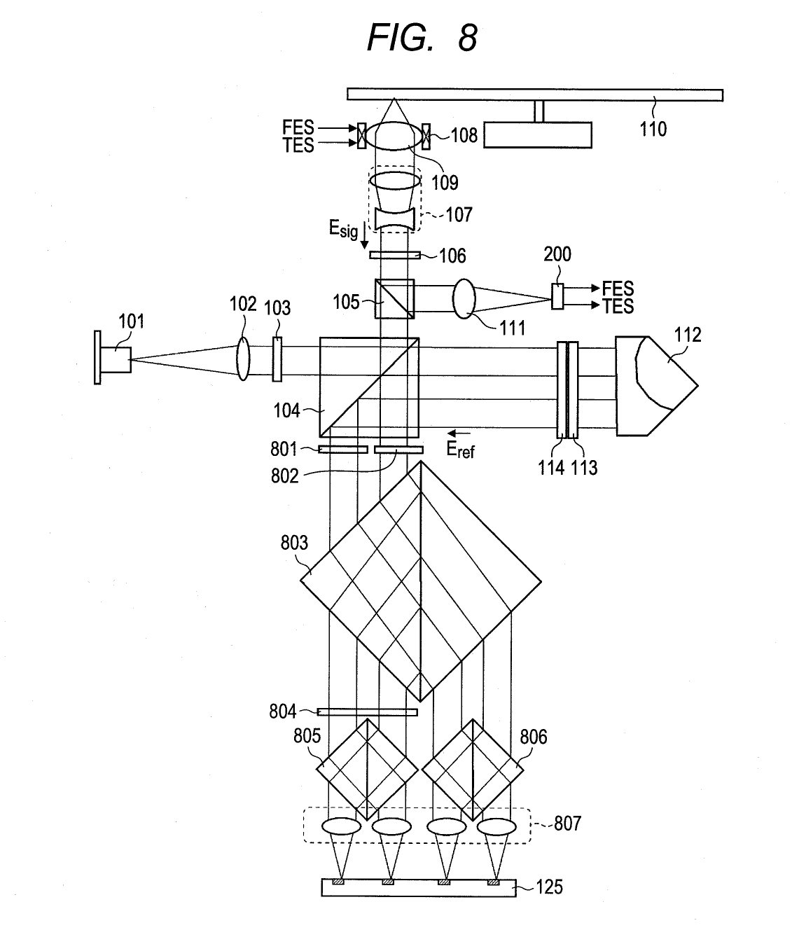

The configuration for splitting the signal light and the reference light that have passed through the polarization beam splitter 104 before multiplexing them in different phase relationships and the configuration for generating interference light are not limited to those of this embodiment. For example, a configuration as shown in FIG. 8 is conceivable. In this case, the signal light and the reference light pass through a half-wave plate (axis direction: 22.5° relative to the horizontal polarization) 801 and a quarter-wave plate (axis direction: 45° relative to the horizontal polarization) 802, respectively, becoming +45° linear polarization and right-handed circular polarization, respectively. These types of polarization are split by a polarization beam splitter 803. The transmitted beams, which are horizontal polarization, are multiplexed by a non-polarization beam splitter 806 to generate interference beams. As for the reflected beams, which are vertical polarization, both the signal light and the reference light pass through a half-wave plate (axis direction: 45° relative to the horizontal polarization direction) 804 and are converted into horizontal polarization and then multiplexed by a non-polarization beam splitter 805 to generate interference beams. The interference beams thus generated are condensed by lenses 807 and then detected and outputted as different electrical signals by different light receptors of the detector 125. In this configuration, the non-polarization beam splitters are used to generate interference beams. Since polarization to be inputted is always horizontal polarization, there is no need to consider the input of vertical polarization in the design of the split ratio, unlike in a beam splitter which is used in the related art and is required to split both horizontal polarization and vertical polarization at a ratio of 1:1. Thus, the split ratio is easily designed. Further, even when horizontal polarization and vertical polarization generate different phase differences, the output of interference light is not affected, since only horizontal polarization is inputted in this configuration.

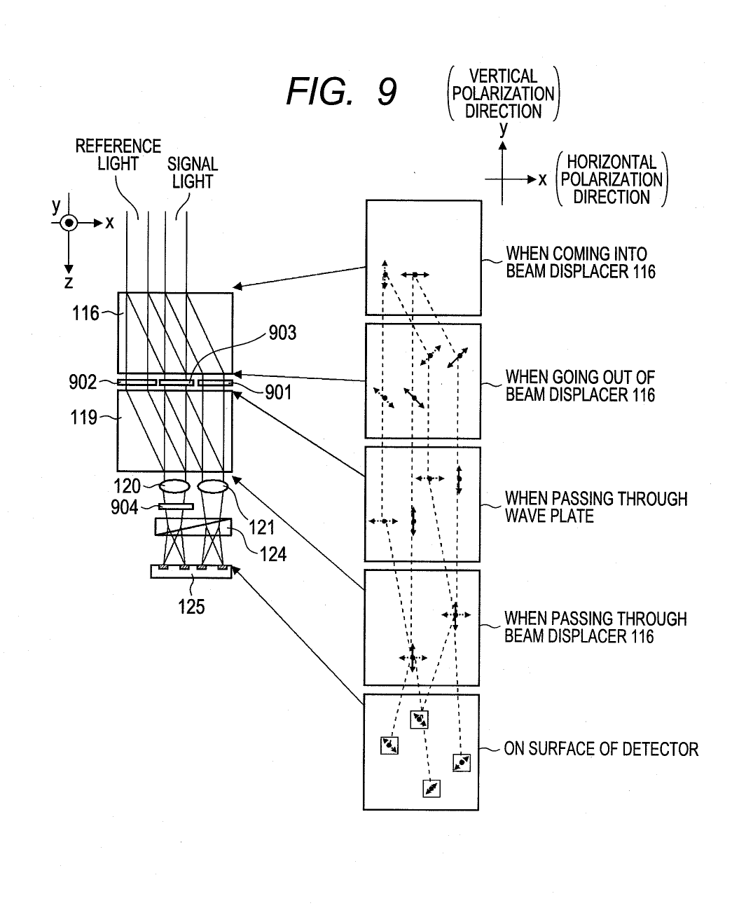

While, in this embodiment, the wave plate(s) is disposed immediately before the beam displacer 116 or Wollaston prism 124, the wave plate(s) is not necessarily required. Polarization rotation caused by the wave plate(s) can be replaced with rotation of a polarization splitter. Specifically, a configuration as shown in FIG. 9 is possible. The respective loci of the beam position and the polarization state in this configuration are shown in the right side of FIG. 9. First, the signal light in a horizontal polarization state and the reference light in a vertical polarization state come into the beam displacer 116. The axis direction of the beam displacer is 45° relative to the horizontal polarization. The beam displacer separates +45° polarization and −45° polarization, and the direction in which the separation is performed with a displacement is a direction of +45°. Of these separated beams, the +45° polarization components of the signal light (the components separated with a displacement) and the −45° polarization components of the reference light (the components separated without a displacement) pass through half-wave plates (axis direction: 22.5° relative to the horizontal polarization direction) 901 and 902, respectively, becoming vertical polarization and horizontal polarization, respectively. The −45° polarization components of the signal light (the components separated without a displacement) and the +45° polarization components of the reference light (the components separated with a displacement) pass through a half-wave plate (axis direction: 67.5° relative to the horizontal polarization direction) 903, becoming horizontal polarization and vertical polarization, respectively. These beams pass through the beam displacer 119 (axis direction: the horizontal polarization direction), and the signal light and the reference light are multiplexed. In one of these multiplexed beams, a phase difference of 90° is made between the signal light and the reference light by a quarter-wave plate (axis direction: the horizontal polarization direction). The two multiplexed beams are split by the Wollaston prism 124. The Wollaston prism 124 is disposed so as to separate +45° linear polarization and −45° linear polarization, and the separation direction is also a direction of ±45°. In this manner, the multiplexed beams are each split to generate interference beams, which are then detected by the detector 125.

### Second Embodiment

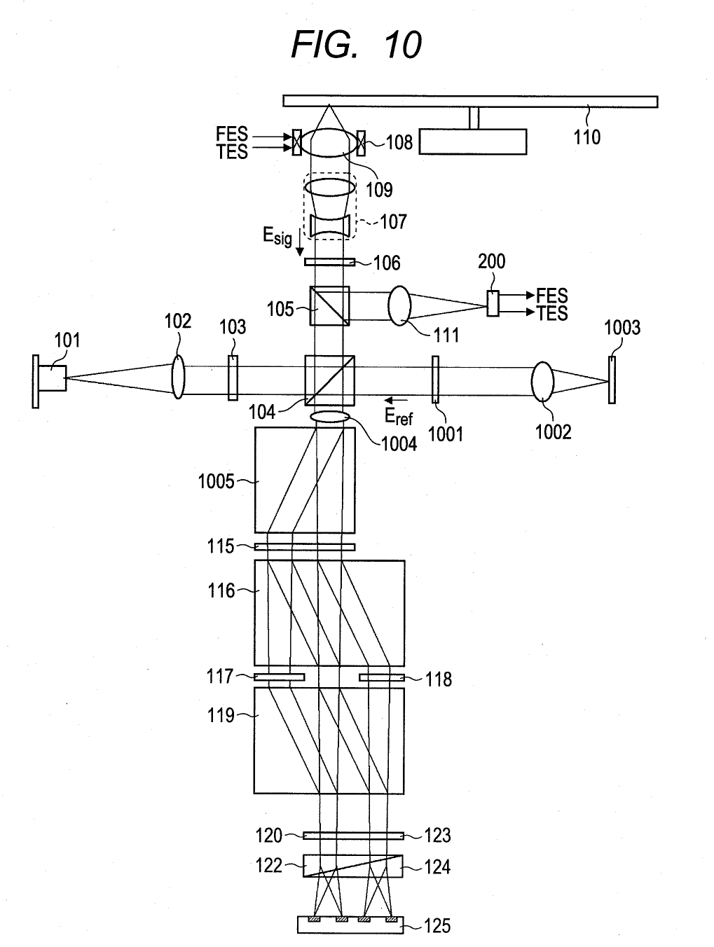

This embodiment is an embodiment where the signal light and the reference light are multiplexed and then split again. FIG. 10 shows a configuration diagram of this embodiment. As in the first embodiment, the signal light is reflected by the optical disc 110, travels back along the optical path, and passes through the polarization beam splitter 104. On the other hand, the reference light passes through a quarter-wave plate (axis direction: 45° relative to the horizontal polarization direction) 1001, is condensed on a mirror 1003 by a lens 1002, reflected by the 1003, travels along the optical path in a 180° opposite direction, and passes through the quarter-wave plate 1001 again. Thus, the polarization is rotated by 90°. When the reference light is reflected by the polarization beam splitter 104, the signal light and the polarization are multiplexed in a perpendicular state. The multiplexed beam is condensed by a lens 1004 and split by a beam displacer 1005 so that the split beams are in parallel with each other. Since the signal light and the reference light are horizontal polarization and vertical polarization, respectively, the multiplexed signal light and reference light is split so that the split signal light and reference light are in parallel with each other. Thus, the signal light and reference light become the same state as those that have passed through the polarization beam splitter 104 in the first embodiment. The signal light and the reference light then undergo the same process as that in the first embodiment and are detected by the detector 125.

In this embodiment, the signal light and the reference light are multiplexed temporarily. Accordingly, with respect to the generated four interference beams, light can be condensed by simply using the single lens for the multiplexed beam as a lens for condensing light. Since the lens for condensing light must be subjected to positional adjustment when mounted, use of this configuration allows reductions in both parts number and adjustment frequency. Further, since the reference light travels along the optical path in a 180° opposite direction, a small optical system can be formed.

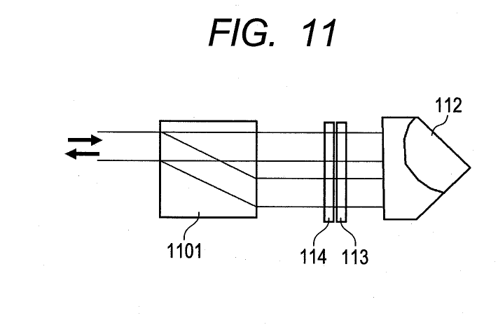

In this embodiment, the reference light is condensed by the lens 1002 and reflected by the mirror 1003. Thus, the optical axis direction of the reference light reflected on the same principle as the signal light is determined with high accuracy. Accordingly, the signal light and the reference light that have passed through the beam displacer 1005 are in parallel with each other with high accuracy and placed in the same state as those in the first embodiment. The device for reflecting the reference light in a 180° opposite direction is not limited to that in this embodiment. For example, as shown in FIG. 11, a configuration may be employed where the beam reflected by the corner cube prism with a displacement is made coaxial with the incident beam by a beam displacer.

### Third Embodiment

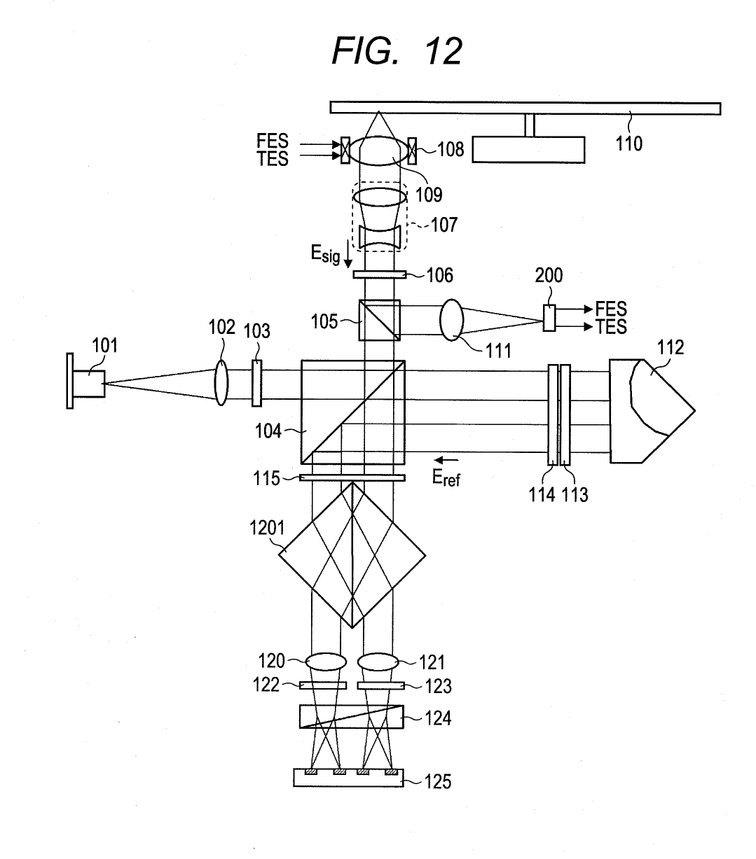

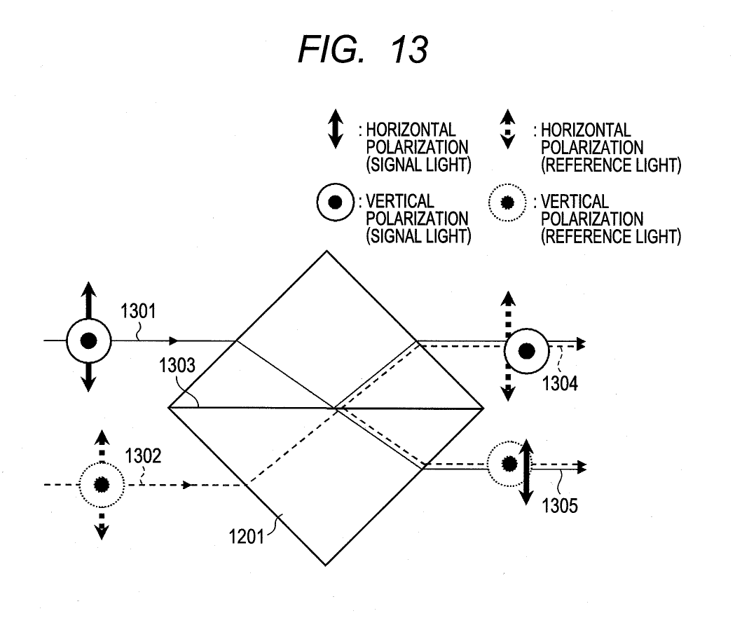

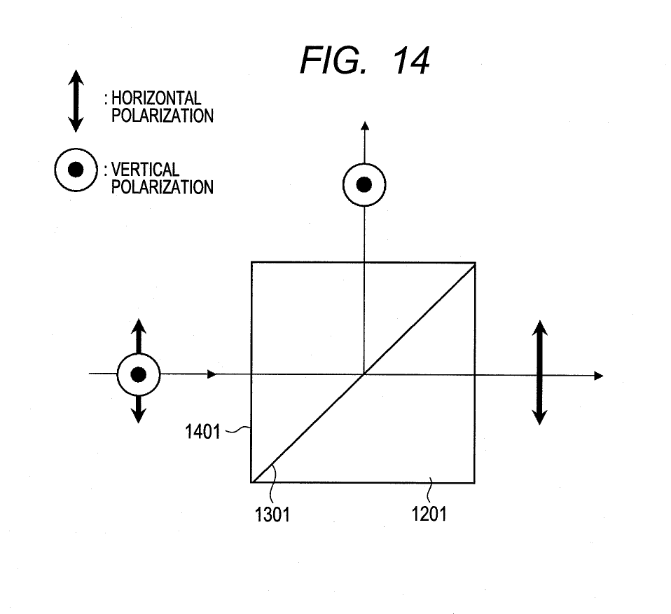

This embodiment is an embodiment where the process of splitting each of the signal light and reference light to cause the signal light and reference light to interfere with each other in different phases and the process of multiplexing the split signal light and reference light are performed simultaneously. FIG. 12 shows a configuration diagram of this embodiment. This embodiment is the same as the first embodiment until the signal light and the reference light pass through a half-wave plate (axis direction: 22.5° relative the horizontal polarization direction) 115. The signal light and the reference light are multiplexed by a polarization beam splitter 1201, and two multiplexed beams go out thereof. The polarization states of the signal light and the reference light at that time are as shown in FIG. 13. The horizontal polarization components of the signal light pass through the polarization beam splitter 1201, as well as are multiplexed with the vertical polarization components of the reference light. Similarly, the vertical polarization components of the signal light pass through the polarization beam splitter 1201, as well as are multiplexed with the horizontal polarization components of the reference light. As seen, two beams obtained by multiplexing the signal light and the reference light in such a manner that respective polarized beams are perpendicular to each other go out of the polarization beam splitter 1201. Thus, the same situation as that immediately after the beam displacer 119 in the first embodiment is realized. These multiplexed beams are detected in the same way as the first embodiment. Note that, as shown in FIG. 13, the polarization beam splitter 1201 is disposed so that the respective optical axis directions of the incoming signal light 1301 and the incoming reference light 1302 are in parallel with a splitting surface 1303. Due to this disposition, outgoing light 1304 and outgoing light 1305 are in parallel with the incoming signal light 1301 and the incoming reference light 1302. This makes it easy to commonly use the components (the Wollaston prism and the detector in this embodiment) for the outgoing light (typically, as shown in FIG. 1, the incident light comes into an incident surface 1401, and the transmitted light and reflected light are directed in different directions).

In this embodiment, the signal light and the reference light are multiplexed by the single polarization beam splitter 1201. Thus, effects similar to those when the beam displacers 116 and 119 and the half-wave plates 117 and 118 are used in the first embodiment are obtained As a result, the parts number is reduced, realizing a simplified optical system configuration.

### Fourth Embodiment

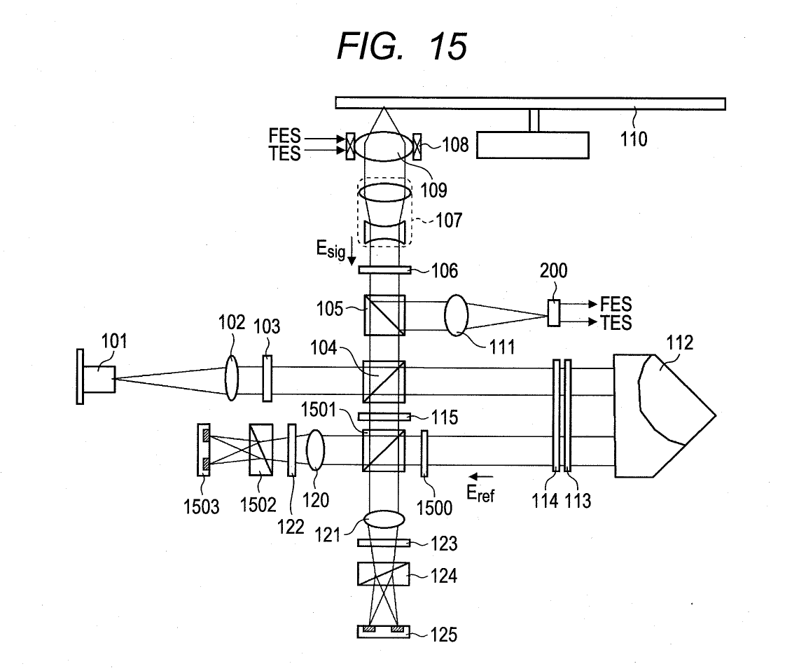

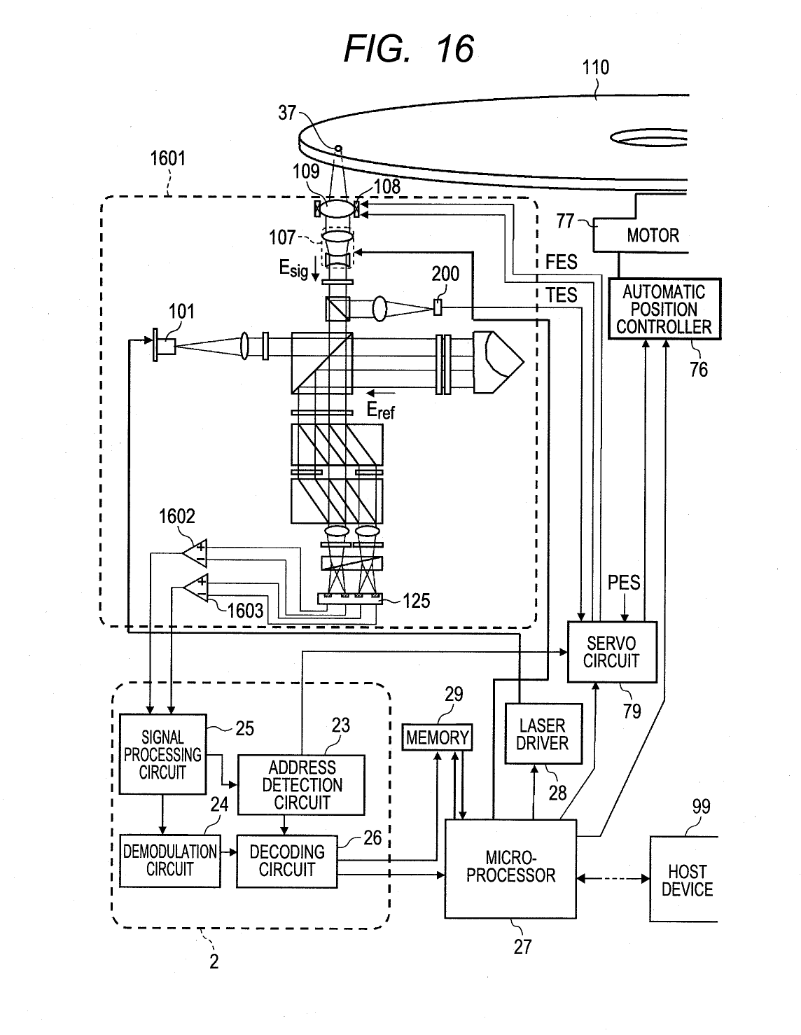

This embodiment is an embodiment where the signal light and the reference light are multiplexed without being made parallel with each other while keeping high the accuracy of the respective optical axis directions. FIG. 15 shows a configuration diagram of this embodiment. As in the first embodiment, the signal light passes through the polarization beam splitter 104 and then passes through the half-wave plate 115 (axis direction: 22.5° relative to the horizontal polarization direction) 115, becoming +45° linear polarization. On the other hand, as in the first embodiment, the reference light is reflected by the corner cube prism 112 in parallel as displaced, and its polarization is rotated by 90° by the half-wave plate 113 and the quarter-wave plate 114. Subsequently, the reference light passes through a half-wave plate (axis direction: 22.5° relative to the horizontal polarization direction) 1500, becoming −45° linear polarization. The signal light and the reference light are multiplexed by a polarization beam splitter 1501, becoming two multiplexed beams. The multiplexing process using the polarization beam splitter 1501 is exactly the same as that using the polarization beam splitter 1201 in the third embodiment. In this process, two multiplexed beams are generated where the signal light and the reference light are placed in a mutually perpendicular polarization state as shown in FIG. 13 (note that, in this embodiment, the incident beams and the multiplexed beams are not in parallel with each other). One of the multiplexed beams passes through the condenser lens 120, the half-wave plate (axis direction: 22.5° relative the horizontal polarization direction) 122, and a Wollaston prism 1502, becoming two interference beams, which are then detected by a detector 1503. Similarly, the other beam passes through the lens 121, the quarter-wave plate (axis direction: 45° relative the horizontal polarization direction) 123, and the Wollaston prism 124, becoming two interference beams, which are then detected by the detector 125.

In this embodiment, unlike in the above-mentioned embodiments, the signal light and the reference light are not in parallel with each other before multiplexed. However, when the signal light and the reference light come into the polarization beam splitter 1501, the respective optical axis directions are determined with high accuracy. Disposition of the polarization beam splitter 1501 with high accuracy allows the signal beam and the reference beam to agree with each other with high accuracy when multiplexed. For that purpose, the splitting surface of the polarization beam splitter 104 and that of the polarization beam splitter 1501 are preferably made parallel with each other with high accuracy. This can be easily realized by a method such as mounting of these polarization beam splitters on the same substrate.

### Fifth Embodiment

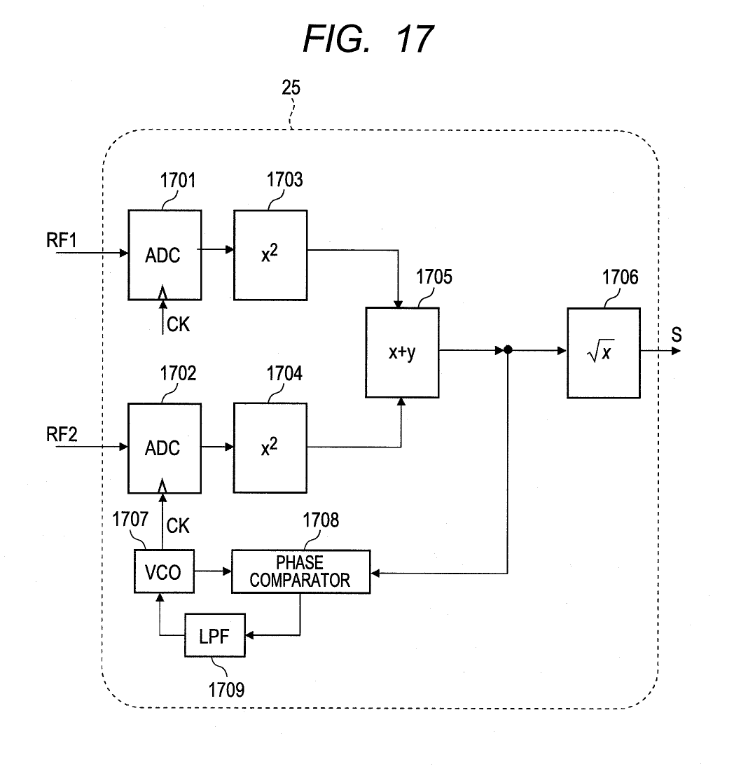

FIG. 16 shows a block diagram of an optical disc apparatus according to one embodiment of the present invention. An optical head 1601 is the same as the first embodiment and outputs the difference between the detection signals of two interference beams generated from the same multiplexed beam from differential circuits 1602 and 1603 as output signals RF1 and RF2. FIG. 17 shows a specific example of the circuit block configuration of a signal processing circuit 25. The output signals RF1 and RF2 from the optical head are digitized by AD conversion circuits 1701 and 1702, squared by square calculation circuits 1703 and 1704, and summed up by a summation circuit 1705. The square root of the summation signal obtained is calculated and outputted as a digital reproduction signal S by a square root calculation circuit 1706. The timing at which the AD conversion circuits 1701 and 1702 perform sampling is generated by making a comparison between the respective phases of the summation signal and the output of a voltage control variable frequency oscillator (VCO) 1707 using a phase comparator 1708, averaging the output of the phase comparator using a low-pass filter (LPF) 1709, and feeding back the averaged output to the control input of the VCO. That is, the timing for AD conversion is controlled by obtaining a clock output (CK) phase-controlled by a PLL (phase-locked loop) circuit composed of the phase comparator 1708, the VCO 1707, and the LPF 1709.

The digital reproduction signal S is subjected to a proper digital equalization process, then inputted into a demodulation circuit 24 and an address detection circuit 23, and sent to a memory 29 and a microprocessor 27 by a decoding circuit 26 as user data. According to an instruction from a host device 99, the microprocessor controls a servo circuit 79 and an automatic position controller 76 and locates an optical spot 37 at any address. According to whether the instruction from the host device indicates playback or recording, the microprocessor 27 controls a driver 28 and causes the laser 101 to emit light with proper power or waveform. The microprocessor 27 also moves the beam expander 107 in the optical axis direction and fixes it to a position where signal quality is best. According to a focus error signal or track error signal obtained from the detector 200, the servo circuit 79 controls the two-dimensional actuator 108 so that light is condensed on the recording surface of the optical disc 110 and follows the recording track.

According to the present invention, it is possible to detect regeneration signals of large-capacity, multilayer, high-speed optical discs with stability and high quality. Thus, a wide variety of industrial applications can be expected including applications to large-capacity video recorders, hard disk data backup devices, storage and information archive devices.

1. An optical head comprising:
a light source;
a polarization splitter that splits a beam emitted by the light source into a signal beam and a reference beam;
a condenser that condenses the signal beam on an optical information recording medium and emits the condensed beam;
a parallel beam emitter that displaces the reference beam and emits the displaced beam so that the displaced reference beam is in parallel with the signal beam reflected in an opposite direction from the optical information recording medium;
a second polarization splitter that splits polarization of the signal beam and polarization of the reference beam;
a multiplexer that multiplexes the signal beam and the reference beam generated by the polarization splitter to generate a multiplexed beam;
an interference beam generator that generates interference beams of the signal beam and the reference beam from the multiplexed beam; and
a detector that detects the interference beams generated by the interference beam generator.

2. The optical head according to claim 1, wherein
the parallel beam emitter comprises:
a parallel beam reflector that displaces the reference beam generated by the polarization splitter and emits the displaced reference beam in parallel; and
the polarization splitter, and
the polarization splitter reflects the reference beam emitted by the parallel beam reflector.

3. The optical head according to claim 2, wherein
the parallel beam reflector is a corner cube prism.

4. The optical head according to claim 2, wherein
the parallel beam reflector comprises:
a condenser that receives the reference beam at a position thereof different from the center axis thereof in such a manner that the reference beam is in parallel with the center axis; and
a mirror disposed at the focus position of the condenser.

5. The optical head according to claim 1, wherein
the parallel beam emitter comprises:
a reflector that emits the reference beam generated by the polarization splitter in a 180° opposite direction without displacing the reference beam;
the polarization splitter that multiplexes the signal beam reflected from the optical information recording medium and the reference beam reflected from the reflector to generate a multiplexed beam; and
a parallel beam separator that separates the signal beam and the reference beam of the multiplexed beam in such a manner that the signal beam and the reference beam are in parallel with each other.

6. The optical head according to claim 5, wherein
the parallel beam separator is a beam displacer.

7. The optical head according to claim 1, wherein
the second polarization splitter and the multiplexer are each a beam displacer.

8. The optical head according to claim 1, wherein
the second polarization splitter and the multiplexer are composed of a single polarization beam splitter.

9. An optical head comprising:
a light source;
a polarization splitter that splits a beam emitted by the light source into a signal beam and a reference beam;
a condenser that condenses the signal beam on an optical information recording medium and emits the condensed beams;
a parallel beam reflector that displaces the reference beam and reflects the displaced reference in parallel;
a polarization multiplexer that multiplexes the signal beam emitted by the optical information recording medium and the reference beam reflected from the parallel beam reflector to generate a multiplexed beam;
an interference beam generator that generates interference beams of the signal beam and the reference beam from the multiplexed beam; and
a detector that detects the interference beams generated by the interference beam generator.

10. An optical disc apparatus comprising:
an optical head including:
a light source;
a polarization splitter that splits a beam emitted by the light source into a signal beam and a reference beam;
a condenser that condenses the signal beam on an optical information recording medium and emits the condensed beam;
a parallel beam emitter that displaces the reference beam and emits the displaced beam so that the displaced reference beam is in parallel with the signal beam reflected in an opposite direction from the optical information recording medium;
a second polarization splitter that splits polarization of the signal beam and polarization of the reference beam;
a multiplexer that multiplexes the signal beam and the reference beam generated by the polarization splitter to generate a multiplexed beam;
an interference beam generator that generates interference beams of the signal beam and the reference beam from the multiplexed beam; and
a detector that detects the interference beams generated by the interference beam generator;
a control unit that controls the respective positions of the optical head and the condenser and the light-emitting state of the light source; and
a signal processing unit that performs an operation using an output of the detector as an input and obtains an output of the operation as a regeneration signal.

11. The optical disc apparatus according to claim 10, wherein the parallel beam emitter comprises:
a parallel beam reflector that displaces the reference beam generated by the polarization splitter and emits the displaced reference beam in parallel; and
the polarization splitter, and
the polarization splitter reflects the reference beam emitted by the parallel beam reflector.

12. The optical disc apparatus according to claim 11, wherein the parallel beam reflector is a corner cube prism.

13. The optical disc apparatus according to claim 11, wherein the parallel beam reflector comprises:
a condenser that receives the reference beam at a position thereof different from the center axis thereof in such a manner that the reference beam is in parallel with the center axis; and
a mirror disposed at the focus position of the condenser.

14. The optical disc apparatus according to claim 10, wherein the parallel beam emitter comprises:
a reflector that emits the reference beam generated by the polarization splitter in a 180° opposite direction without displacing the reference beam;
the polarization splitter that multiplexes the signal beam reflected from the optical information recording medium and the reference beam reflected from the reflector to generate a multiplexed beam; and
a parallel beam separator that separates the signal beam and the reference beam of the multiplexed beam in such a manner that the signal beam and the reference beam are in parallel with each other.

15. The optical disc apparatus according to claim 14, wherein the parallel beam separator is a beam displacer.

16. The optical disc apparatus according to claim 10, wherein the second polarization splitter and the multiplexer are each a beam displacer.

17. The optical disc apparatus according to claim 10, wherein the second polarization splitter and the multiplexer are composed of a single polarization beam splitter.

18. An optical disc apparatus comprising:
an optical head including:
a light source;
a polarization splitter that splits a beam emitted by the light source into a signal beam and a reference beam;
a condenser that condenses the signal beam on an optical information recording medium and emits the condensed beams;
a parallel beam reflector that displaces the reference beam and reflects the displaced reference in parallel;
a polarization multiplexer that multiplexes the signal beam emitted by the optical information recording medium and the reference beam reflected from the parallel beam reflector to generate a multiplexed beam;
an interference beam generator that generates interference beams of the signal beam and the reference beam from the multiplexed beam; and
a detector that detects the interference beams generated by the interference beam generator;
a control unit that controls the positions of the optical head and the condenser and the light-emitting state of the light source; and
a signal processing unit that performs an operation using an output of the detector as an input and obtains an output of the operation as a regeneration signal.
